(19) United States
(12) Patent Application Publication
(10) Pub. No.: US 2021/0281909 A1
(43) Pub. Date: Sep. 9, 2021

(54) METHOD AND APPARATUS FOR SHARING VIDEO, AND STORAGE MEDIUM

(71) Applicant: BEIJING DAJIA INTERNET INFORMATION TECHNOLOGY CO., LTD., Beijing (CN)

(72) Inventor: Bingyang Xiong, Beijing (CN)

(21) Appl. No.: 17/108,033

(22) Filed: Dec. 1, 2020

(30) Foreign Application Priority Data
Mar. 6, 2020 (CN) 202010153247.2

(51) Int. Cl. H04N 21/43; H04N 21/2187; H04N 21/2743; H04N 21/482

(52) U.S. Cl. CPC H04N 21/43076; H04N 21/4826; H04N 21/2743; H04N 21/2187

(57) ABSTRACT

The disclosure relates to solutions for sharing a video. A first terminal may execute steps of acquiring a control operation of a first user account for a target video, in which the target video is in a virtual space interface of the first user account; obtaining video operation information corresponding to the control operation by processing the target video in response to the control operation; and synchronizing the video operation information to a second terminal, in which the second terminal is in a same virtual space as the first terminal.

### CROSS-REFERENCE TO RELATED APPLICATION

The present application is based on and claim priority to Chinese Patent Application No. 202010153247.2, filed with the China National Intellectual Property Administration on March 6, 2020, the disclosures of which are herein incorporated by reference in its entirety.

### FIELD

The disclosure relates to network technology, and in particular to a method and apparatus for sharing a video, and a non-transitory computer-readable storage medium.

### BACKGROUND

With the development of computer technology, media consumptions such as short videos, TV shows, and movies have become common in people's lives.

### SUMMARY

The disclosure provides a method and apparatus for sharing a video. The technical solutions of the disclosure are described as follows.

Embodiments of the disclosure provide a method for sharing a video, which is applied to a first terminal. The method includes: acquiring a control operation of a first user account for a target video, in which the target video is in a virtual space interface of the first user account; obtaining video operation information corresponding to the control operation by processing the target video in response to the control operation; and synchronizing the video operation information to a second terminal, in which the second terminal is in a same virtual space as the first terminal.

Embodiments of the disclosure provide a method for sharing a video, which is applied to a second terminal. The method includes: obtaining video operation information of a target video synchronized from a first terminal, in which the first terminal and the second terminal are in a same virtual space; and processing the target video in a virtual space interface of a first user account based on the video operation information.

Embodiments of the disclosure provide an apparatus for sharing a video, which is applied to a first terminal. The apparatus includes: one or more processors; a memory coupled to the one or more processors, a plurality of instructions stored in the memory, when executed by the one or more processors, causing the one or more processors to perform acts of: acquiring a control operation of a first user account for a target video, in which the target video is in a virtual space interface of the first user account; obtaining video operation information corresponding to the control operation by processing the target video in response to the control operation; and synchronizing the video operation information to a second terminal, in which the second terminal is in a same virtual space as the first terminal.

Embodiments of the disclosure provide a non-transitory computer-readable storage medium. The storage medium is applied to a first terminal. When an instruction stored in the storage medium is executed by a processor in an electronic device, the processor is caused to perform acts including: acquiring a control operation of a first user account for a target video, in which the target video is in a virtual space interface of the first user account; obtaining video operation information corresponding to the control operation by processing the target video in response to the control operation; and synchronizing the video operation information to a second terminal, in which the second terminal is in a same virtual space as the first terminal.

It should be understood that the above general description and the following detailed description are only exemplary and explanatory, and cannot limit the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, and do not constitute an improper limitation of the present disclosure.

FIG. 1 illustrates a diagram showing an application environment of a method for sharing a video based on an embodiment of the disclosure.

FIG. 2 illustrates a flowchart of a method for sharing a video based on an embodiment of the disclosure.

FIG. 2A illustrates a schematic diagram of a virtual space interface based on an embodiment of the disclosure.

FIG. 2B illustrates a schematic diagram of a virtual space interface based on another embodiment of the disclosure.

FIG. 2C illustrates a schematic diagram of a virtual space interface based on yet another embodiment of the disclosure.

FIG. 2D illustrates a schematic diagram of a virtual space interface based on still another embodiment of the disclosure.

FIG. 2E illustrates a schematic diagram of a virtual space interface based on yet still another embodiment of the disclosure.

FIG. 3 illustrates a flowchart of a method for sharing a video based on another embodiment of the disclosure.

FIG. 3A illustrates a schematic diagram of a virtual space interface based on an embodiment of the disclosure.

FIG. 3B illustrates a schematic diagram of a virtual space interface based on another embodiment of the disclosure.

FIG. 3C illustrates a schematic diagram of a virtual space interface based on yet another embodiment of the disclosure.

FIG. 3D illustrates a schematic diagram of a virtual space interface based on still another embodiment of the disclosure.

FIG. 4 illustrates a block diagram of an apparatus for sharing a video based on an embodiment of the disclosure.

FIG. 5 illustrates a block diagram of an apparatus for sharing a video based on another embodiment of the disclosure.

FIG. 6 illustrates a diagram of an internal structure of an electronic device based on an embodiment of the disclosure.

### DETAILED DESCRIPTION

In order to enable those skilled in the art to understand the technical solutions of the present disclosure, reference will be made clearly and completely technical solutions in the embodiments of the present disclosure with accompanying drawings.

It should be noted that terms “first” and “second” in the specification and claims of the present disclosure and the accompanying drawings are used to distinguish similar objects, rather than to describe a specific order or sequence. It should be understood that data used in such a manner may be interchanged under appropriate circumstances so that embodiments of the present disclosure described herein may be implemented in a sequence other than the sequence illustrated or described herein. The implementations described in the following exemplary embodiments do not represent all implementations consistent with the present disclosure; instead, the implementations described in the following exemplary embodiments are merely examples of an apparatus and method consistent with the attached claims and some aspects of the present disclosure.

In related arts, when a user needs to share a certain video content with other users online, the video name of the video to be shared is usually shared with other users, and other users search for and watch the video based on the video name, or the user shares the network link of the video to other users, and other users open the network link to watch the video. Each user may only watch the video alone, and it is difficult to watch the video simultaneously in real time.

The method for sharing a video provided in the disclosure can be applied to a live broadcast scene. The definition of terminal roles in the live broadcast scene will be explained as follows. Anchor refers to the current broadcaster which is equivalent to a host, who can actively invite users to connect to the microphone or approve the request of the current audience to connect to the microphone, or can disconnect the connection of a certain microphone. The video on the anchor side is generally displayed in full screen.

Guest refers to an audience participating in the current microphone connection, who can apply to connect the microphone to the anchor, or accept the anchor's invitation to connect the microphone for audio and/or video. When the guest don not want to connect the microphone, those who participates in the connection can disconnect the connection actively.

Audience refers to an audience of the live broadcast.

Live server is used to manage the connection sessions between a host and another host, or between a host and a guest, realizing the scheduling and computing capabilities of the audio and video cloud. Specifically, it will include a signaling server, a streaming media server cluster, etc.

Content distribution network is used to receive media data sent by anchors and/or guests, provides buffering, storage and forwarding capabilities, and distributes live content to viewers.

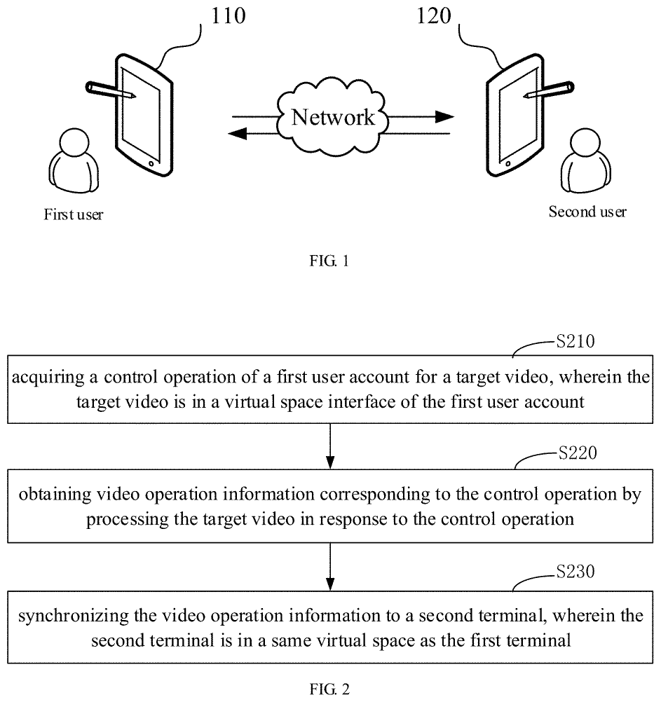

The method for sharing a video provided by the disclosure can be applied to the application environment as shown in FIG. 1. The first terminal 110 performs interactive communication with the second terminal 120 through the network. The first terminal 110 and the second terminal 120 may be, but not limited to, various personal computers, notebook computers, smart phones, tablet computers, and portable wearable devices. The first user or the second user operates the first terminal 110 or the second terminal 120 through the interface, and the first terminal 110 or the second terminal 120 triggers the corresponding instruction when it detects that the first user or the second user is operating the interface, and performs the corresponding operation based on the triggered instruction. Specifically, the first user operates the first terminal 110, and the first terminal 110 obtains the control operation of the first user account for the target video in the virtual space interface of the first user account, and the first user account has the first user account with a predetermined authority. The first user may process the target video based on the control operation to obtain video operation information corresponding to the control operation, and synchronize the processed video operation information of the target video to the second terminal 120 in the same virtual space as the first terminal, so that the second terminal 120 synchronously plays the target video based on the video operation information.

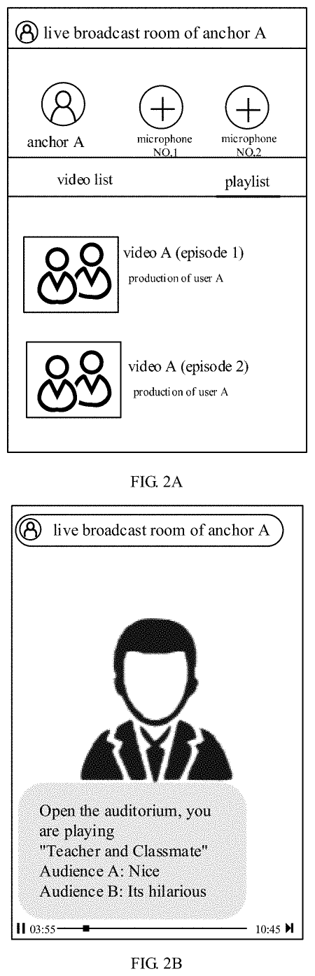

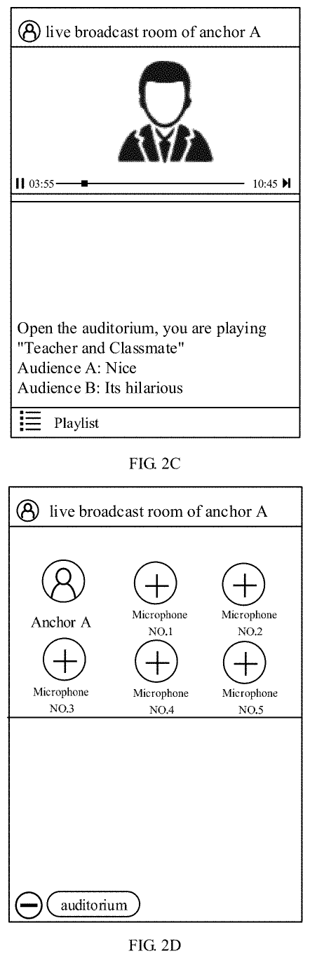

FIG. 2 is a flowchart of a method for sharing a video based on an embodiment of the disclosure. As shown in FIG. 2, the method for sharing a video is applied in the first terminal shown in FIG. 1, and the method for sharing a video includes the following steps.

In step S210, a control operation of a first user account for a target video is acquired, in which the target video is in a virtual space interface of the first user account.

In detail, in the virtual space interface of the first user account, the control operation of the first user account for the target video is obtained, and the first user account is a user account with a first predetermined authority.

The first user account refers to a user account with the first predetermined authority. For example, in a live broadcast application scenario, the first user account refers to a user account with the host authority, that is, the host account for the live broadcast, which can control various functions in the live broadcast room, such as sending microphone requests to guests, pausing the target video, etc. The virtual space interface is a page used to represent the virtual space displayed on the first terminal. For example, in a live broadcast application scenario, the virtual space may refer to the live room where the host initiates the live broadcast, and the virtual space interface may refer to an interface of the live room. The virtual space interface includes video information of multiple different videos, such as video name, video cover, and video screen of the currently played video.

Specifically, the first terminal detects in real time the control operation of the first user account on the target video in the virtual space interface. The control operation can be triggered by clicking a virtual button in the virtual space interface displayed on the touch display screen of the first terminal, or by pressing a physical button of the first terminal, or by voice control, which is not limited herein.

For example, when the first user uses a live broadcast application, the first user may initiate a live broadcast by clicking an icon configured to initiate the live broadcast on the application homepage interface displayed on the first terminal and triggering the application to enter the live broadcast of the first user account. In the meantime, after the first terminal detects a click operation on the icon of live broadcast on the application homepage interface, an instruction for entering the live broadcast room may be triggered, and the terminal may switch from displaying the homepage interface to the interface of the live broadcast room displaying the first user account. As shown in FIG. 2A, at this time, the first terminal detects in real time the first user's operation on the target video in the virtual space interface, and when it detects the first user's operation on the target video in the virtual space interface, the control operation of the first user account on the target video in the virtual space interface is obtained.

In step S220, video operation information corresponding to the control operation is obtained by processing the target video in response to the control operation.

In detail, the target video is processed based on the control operation, and video operation information corresponding to the control operation is obtained.

After the first terminal obtains the control operation of the first user account on the target video in the virtual space interface, in response to the first user's control operation on the target video in the virtual space interface, the first terminal processes the target video correspondingly, and obtains the video operation information of the target video.

For example, when a play operation of the target video in the virtual space interface by the first user account is obtained, the first terminal plays the target video in the virtual space interface in response to the play operation. Optionally, playing the video stream data of the target video in the virtual space interface may be playing the video stream data in full-screen mode in the virtual space interface of the first terminal, as shown in FIG. 2B; or playing the video stream data in a half-screen mode in the virtual space interface of the first terminal, as shown in FIG. 2C. In this regard, the manner of playing the video stream data of the target video in the virtual space interface can be set based on actual requirements, which is not limited in embodiments of the disclosure.

For another example, a target video has been played in the virtual space interface, the first user clicks on the pause virtual button in the virtual space interface, the first terminal obtains the pause operation of the first user account on the target video in the virtual space interface, and the first terminal stops playing the target video in response to the pause operation.

For another example, a target video has been played in the virtual space interface, the first user clicks on the fast forward virtual button in the virtual space interface, the first terminal obtains the fast forward operation of the first user account on the target video in the virtual space interface, and the first terminal plays the target video at a speed of 1.5 times in response to the fast forward operation.

For another example, a target video has been played in the virtual space interface, the first user clicks on the back virtual button in the virtual space interface, the first terminal obtains the back operation of the first user account on the target video in the virtual space interface, and the first terminal controls the target video to return to the frame picture 10 seconds ago and to continue playing in response to the back operation.

In step S230, the video operation information is synchronized to a second terminal, in which the second terminal is in a same virtual space as the first terminal.

That is, the video operation information of the target video is synchronized to a second terminal in a same virtual space as the first terminal.

The second terminal and the first terminal are in the same virtual space, and the number of second terminal is one or more. For example, in a live broadcast application scenario, the second terminal refers to a terminal that enters the live broadcast room of the first user account, the second terminal may refer to the terminal corresponding to the audience or the terminal corresponding to the guest. After processing the target video on the virtual space interface, the first terminal may obtain the video operation information of the target video, thereby synchronizing the video operation information of the target video to the second terminal, so that the second terminal can adjust a play status of the target video based on the received video operation information, and the target video is played synchronously on the first terminal and the second terminal. Specifically, the video operation information may include the video identifier and control operation information of the target video, and the processed video operation information of the target video is synchronized to the second terminal, which may specifically be played in the virtual space of the first user. The video identifier of the target video is uploaded to the live server, and the control operation information of the target video is obtained in real time, and the control operation information of the target video is uninterrupted or intermittently synchronized to the second terminal that enters the same virtual space as the first terminal. Correspondingly, the second terminal may initiate a request to enter the virtual space of the first user to the live broadcast server. After receiving the request, the live broadcast server returns the video identifier of the target video in the virtual space of the first user to the second terminal. The video stream data of the target video is pulled from the video server based on the video identifier of the target video, and the control operation information is obtained in real time, and then the target video is processed synchronously based on the control operation information to realize the synchronization of playing the target video on the first terminal and the second terminal.

In the above method for sharing a video, in the virtual space interface of the first user account, the control operation of the first user account for the target video is obtained, and the first user account is a user account with a first predetermined authority; the target video is processed based on the control operation to obtain video operation information corresponding to the control operation. The processed video operation information of the target video is synchronized to the second terminal, and the second terminal is in the same virtual space as the first terminal, so that multiple terminals in the virtual space can simultaneously play the same video and display the same video screen. At the same time, it can effectively increase the diversification of live broadcasts and provide host users with more production tools to allow them to produce more high-quality content.

In some embodiments, the step of processing the video stream data of the target video based on the control operation includes: obtaining the video stream data of the target video from the video server in response to the play operation of the first user account on the target video, and playing the video stream data of the target video in the virtual space interface.

Specifically, when the play operation of the target video in the virtual space interface by the first user account is obtained, the first terminal plays the target video in the virtual space interface in response to the play operation, and displays the target video. The video server stores video stream data of multiple videos, and the video stream data includes video data and/or audio data. The video server and the live broadcast server may be the same server or different servers.

In some embodiments, the step of processing the video stream data of the target video based on the control operation includes: pausing the target video in the virtual space interface in response to a pause operation of the first user account on the target video.

Specifically, a target video has been played in the virtual space interface, the first user clicks on the pause virtual button in the virtual space interface, the first terminal obtains the pause operation of the first user account on the target video in the virtual space interface, and the first terminal stops playing the target video in response to the play operation.

In some embodiments, the video operation information includes a video identifier and control operation information of the target video, and the step of synchronizing the video operation information of the target video to the second terminal includes: uploading the video identifier of the target video to a live broadcast server, and sending the target video identifier to the second terminal through the live broadcast server; establishing a persistent connection with the second terminal, and broadcasting the control operation information of the target video which is determined as broadcasting information to the second terminal.

After obtaining the video operation information of the target video, the first terminal uploads the video identifier of the target video played in the live broadcast room of the first user to the live broadcast server. At the same time, the first terminal can establish a persistent connection with the second terminal entering the live broadcast room of the first user, generate broadcast information based on the control operation information of the target video, and broadcast the control operation information of the target video to the second terminal by establishing a persistent connection with the second terminal, thereby effectively reducing the time delay of information transmission, such that the information delay time between the second user account and the first user may be reduced, and video synchronization between the second user account and the first user may be ensured. For example, the first terminal can establish a persistent connection with the second terminal based on the UDP protocol (User Datagram Protocol), and the UDP-based broadcast function allows that the control operation information of the target video may be continuously broadcasted to the second terminal. When the second user subsequently watches the live broadcast in the live broadcast room of the first user through the corresponding second terminal, the second terminal may initiate a request for viewing the live broadcast in the first user's live broadcast room to the live broadcast server. After receiving the request, the live broadcast server returns the video identifier of the target video played in the live broadcast room of the first user to the second terminal. After receiving the control operation information broadcasted by the first terminal through the persistent connection, the video stream data of the target video is played synchronously based on the control operation information, such that the target video may be synchronized and played on the first terminal and the second terminal.

In some embodiments, the video operation information includes the video identifier and control operation information of the target video, and the step of synchronizing the video operation information of the target video to the second terminal includes: uploading the video identifier of the target video to the live broadcast server, and sending the target video identifier to the second terminal through the live broadcast server; writing the control operation information into streaming media data of the live stream, and distributing the control operation information to the second terminal through a content distribution network.

After obtaining the video identifier of the target video of the target video, the first terminal uploads the video identifier of the target video played in the live broadcast room of the first user to the live broadcast server. At the same time, the first terminal continuously obtains the control operation information of the target video, writes the status information of the target video into the streaming media data of the live stream, uploads the streaming media data of the live stream to the source station of the content distribution network, and sends the control operation information to the second terminal entering the live broadcast room of the first user through the content distribution network. For example, after obtaining the video operation information of the target video, the first terminal can generate audio synchronization data (namely, Advanced Audio Syncing, AAC) with the control operation information of the target video in the Protobuf (Google Protocol Buffer) data storage format, write the audio synchronization data into the streaming media data of the live stream and upload the same to the source station of the content distribution network. Subsequently, in a case that the second terminal is corresponding to the second user account, when the second user watches the live broadcast in the live broadcast room of the first user through the corresponding second terminal, the second terminal may initiate a request for viewing the live broadcast in the first user's live broadcast room to the live broadcast server. After receiving the request, the live streaming server returns the video identifier of the target video played in the live streaming room of the first user to the second terminal, and at the same time, the second terminal sends the request to the content distribution network, pulls the streaming media data of the live stream of the first user's live room from the content distribution network, and after real-time video operation information is obtained from the streaming media data, the video stream data of the target video is played synchronously based on the video operation information, such that the target video is played synchronously on the first terminal and the second terminal.

In the live broadcast application scenario, the second terminal includes an audience terminal corresponding to the audience and a guest terminal corresponding to the guest. During synchronizing the processed video operation information of the target video to the second terminal, the first terminal can establish a persistent connection with the guest terminal and the audience terminal respectively, and broadcast the control operation information of the target video which is determined as broadcast information to the guest terminal and the audience terminal. The first terminal may write the control operation information into the streaming media data of the live stream, and distributes the same to the audience terminal and the guest terminal through the content distribution network, or, the first terminal may establish a persistent connection with the guest terminal, broadcast the control operation information of the target video which is determined as broadcast information to the guest terminal, write the control operation information into the streaming media data of the live stream, and distribute the same to the audience terminal through a content distribution network. Here, the manner of the first terminal synchronizing the processed video operation information of the target video to the guest terminal and the audience terminal is not specifically limited herein.

In some embodiments, the method for sharing a video further includes: obtaining a recommended channel and a list of recommended videos under the recommended channel based on account information of the first user account, in which the list of recommended videos includes multiple recommended videos; displaying the recommended channel and the recommended videos under the recommended channel in the virtual space interface.

Account information refers to information data that identifies characteristics of a user account, such as user ID, user level, user region, user age, gender category label, etc. After entering the virtual space interface of the first user, the user information of the first user can be obtained, and the recommended channel and the list of the recommended videos under the recommended channel can be obtained from the video database based on the user information, and the recommended channel and recommended videos under recommended channel is displayed in the virtual space interface.

For example, when using a live broadcast application, the first user clicks an icon configured to indicate the live broadcast on the homepage interface of the application displayed on the first terminal, which triggers the application to enter the virtual space interface of the first user as shown in FIG. 2D. At this time, by clicking the auditorium icon in the virtual space interface, the video selection panel at the bottom of the virtual space interface as shown in FIG. 2E can be displayed in the corresponding virtual space interface, thereby jumping to the virtual space interface as shown in FIG. 2E. Different recommended channels and the recommended video list under the current recommended channel are displayed on the video selection panel, as shown in FIG. 2E, four recommended channels including “Featured”, “Daily Love”, “Campus Love”, and “Social Boss” are displayed in the video selection panel, among which the “Campus Love” channel is the current recommended channel. There are videos such as “Jia and Jiao” and “Girls' Stars Dream” under this recommended channel.

Further, in some embodiments, the step of obtaining the recommended channel and the list of recommended videos under the recommended channel based on user information of the first user includes: obtaining channel data based on account information of the first user account, and creating a channel list; determining the recommended channel from a channel list, and obtain the list of the recommended videos under the recommended channel based on the channel identifier of the recommended channel.

In some embodiments, the method for sharing a video further includes: displaying a video search window in the virtual space interface; obtaining the video keywords inputted by the first user account in the video search window, and displaying videos related to the video keywords on the virtual space interface.

In the embodiments of the disclosure, in order to facilitate obtaining the video that the first user (that is, the anchor) wants to watch, the virtual space interface provides a video search window to provide a video database search function. Specifically, the first terminal displays a video search window on the virtual space interface, and the first user can input any customized content in the video search window through the interface operation. When the input is completed, the first terminal can obtain the first user input as the video keywords, search for videos related to the video keywords in the video database, and display the searched videos in the virtual space interface.

For example, the first user can operate through the interface, enter the customized content “Empresses in the Palace” in the video search window of the virtual space interface as shown in FIG. 2E, and the first terminal obtains the customized content “Empresses in the Palace” inputted by the first user. After “Empresses in the Palace” is used as the video keyword, videos related to the keywords “Empresses in the Palace” are searched in the video database, and the retrieved videos are displayed in the virtual space interface.

In some embodiments, the method for sharing a video further includes: collecting first speech information in an environment where the first terminal is located; generating streaming media data of the live stream based on the first speech information, and distributing the streaming media data of the live stream to the second terminal.

In the embodiment of the disclosure, after the target video is played in the live broadcast room of the first user, the first user can send speech information to the second user account, so that multiple users can chat while watching the video. The first speech information includes the chat speech of the first user. After playing the video stream data of the target video in the virtual space interface, the first terminal also collects the first speech information in the environment where the first terminal is located, generates the streaming media data of the live stream from the collected first speech information, and broadcasts the streaming media data of the live stream to the second terminal entering the live broadcast room of the first user.

Specifically, the first terminal continuously obtains the first speech information in the environment where the first terminal is located, and generates the streaming media data of the live stream based on the first speech information in the environment where the first terminal is located, and then uploads the streaming media data of the live stream to the source station of the content distribution network. When the second user account subsequently enters the live broadcast room of the first user through the corresponding second terminal to watch the live broadcast, the second terminal can initiate a request for viewing the live broadcast in the first user's live broadcast room to the live broadcast server, and pull the streaming media data of the live stream of the first user's live broadcast room from the content distribution network, and obtain real-time first speech information in the environment where the first terminal is located from the streaming media data.

In some embodiments, the step of generating streaming media data of the live stream based on the first speech information further includes: receiving second speech information in the environment where the second terminal is located, which is collected by the second terminal; generating the streaming media data of the live stream based on the first speech information and the second speech information.

In the embodiment of the disclosure, the second user account can perform voice chat with the first user through the second terminal, so that multiple users can connect to the microphone and chat while watching videos. The second speech information includes the chat speech of the second user account. After playing the video stream data of the target video in the virtual space interface, the second terminal also collects the second speech information in the environment where the second terminal is located, and sends the collected second speech information to the first terminal. After receiving the second speech information sent by the second terminal, the first terminal combines the first speech information and the second speech information to generate the streaming media data of the live stream, and distributing the streaming media data of the live stream to the second terminal entering the live broadcast room of the first user.

Specifically, the first terminal can establish a persistent connection with the second terminal entering the live broadcast room of the first user, and the second terminal communicates with the first terminal through the persistent connection, so that the second speech information is sent to the first terminal, thereby effectively reducing the speech information delays. After receiving the second speech information sent by the second terminal, the first terminal combines the first speech information and the second speech information to generate streaming media data of the live stream, and uploads the streaming media data of the live stream to the source station of the content distribution network. When the subsequent audience user enters the first user's live broadcast room to watch the live broadcast through the corresponding audience terminal, the audience terminal can initiate a request for viewing the live broadcast in the first user's live broadcast room to the live broadcast server, and pull the streaming media data of the live stream in the first user's live broadcast room from the content distribution network, and obtain real-time first speech information in the environment where the first terminal is located and second speech information in the environment where the second terminal is located from the streaming media data.

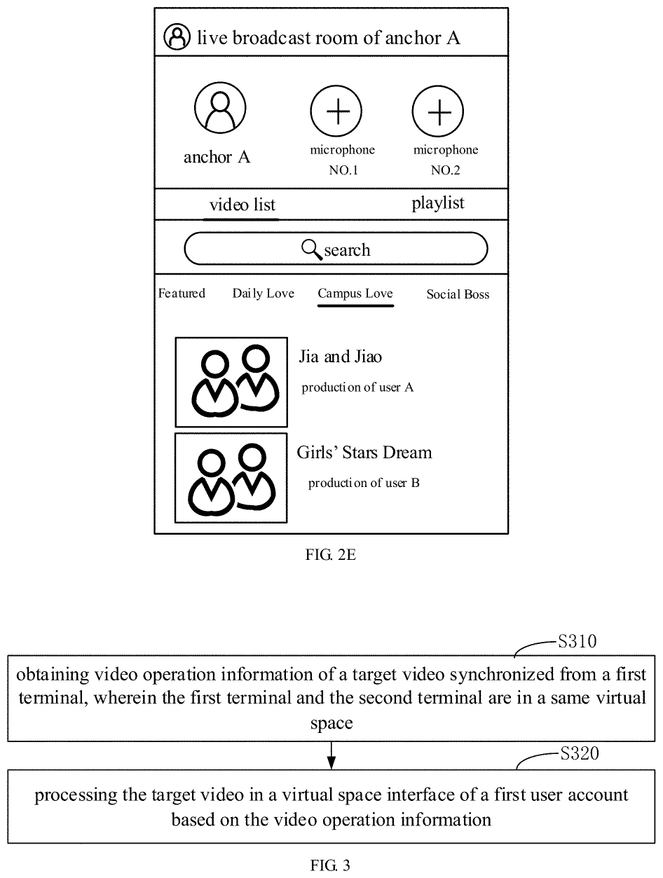

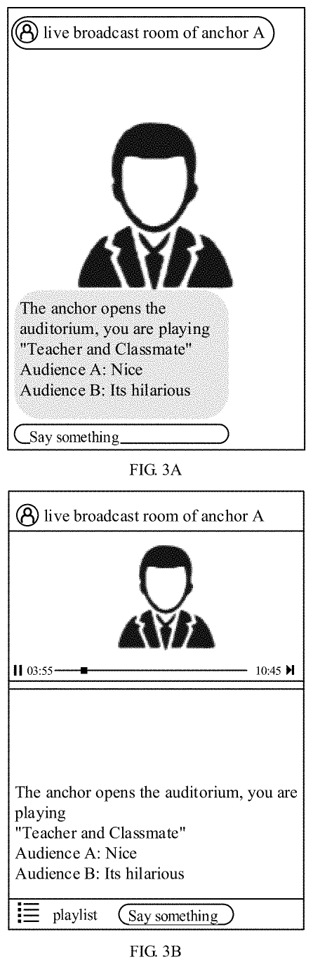

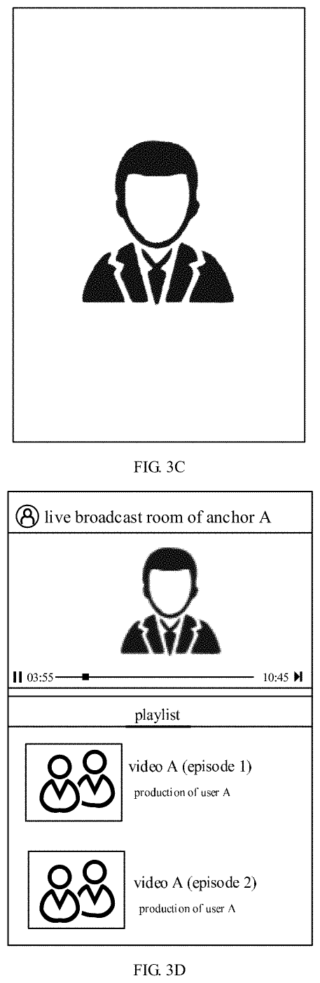

FIG. 3 is a flowchart of a method for sharing a video based on an embodiment. As shown in FIG. 3, the method for sharing a video is applied to the second terminal shown in FIG. 1. The method includes the following steps.

In step S310, video operation information of a target video synchronized from a first terminal is obtained, in which the first terminal and the second terminal are in a same virtual space.

In detail, video operation information for the target video synchronized by the first terminal is obtained.

In step S320, the target video in a virtual space interface of a first user account is processed based on the video operation information.

In detail, in the virtual space interface of the first user account, the target video is processed based on a control operation corresponding to the video operation information.

The second terminal refers to a terminal corresponding to the second user account, and the second user account is a user account with a second predetermined authority. For example, in a live broadcast application scenario, the second user includes audiences and guests, and the second user account refers to a virtual account corresponding to an audience or a guest.

The second terminal obtains the video operation information of the target video synchronized by the first terminal, and processes the target video in the virtual space interface of the first user account based on the control operation corresponding to the video operation information, so that the second terminal synchronizes with the first terminal in the virtual space during the process of playing the target video, and displays the same video screen.

In some embodiments, the step of processing the target video based on the control operation corresponding to the video operation information includes: obtaining video stream data of the target video from a video server; synchronizing and playing the target video in the virtual space interface based on the video stream data of the target video and the play operation information.

In detail, the video operation information includes a video identifier and control operation information, and the control operation information includes play operation information or pause operation information. the step of processing the target video may include: obtaining video stream data of the target video from a video server based on the video identifier; and playing the video stream data in the virtual space interface based on the video stream data and the play operation information. the step of obtaining the video operation information may include: establishing a persistent connection with the first terminal; and receiving the video operation information broadcasted by the first terminal through the persistent connection. The step of obtaining the video operation information may include: pulling streaming media data of a live stream from a content distribution network, in which the streaming media data is uploaded to the content distribution network by the first terminal; and obtaining the video operation information from the streaming media data.

The second terminal obtains the play operation information of the target video synchronized with the first terminal, and obtains the video stream data of the target video from the video server based on the video identifier of the target video in the play operation information. The second terminal processes the target video in a virtual space interface of the first user account based on the control operation information in the play operation information, plays the target video and displays the same video screen in the virtual space interface. Optionally, the second terminal plays the video stream data of the target video in the virtual space interface of the first user displayed on the second terminal in a full screen manner, as shown in FIG. 3A, or in a half-screen manner as shown in FIG. 3B, or in a clear screen manner as shown in FIG. 3C. When the video stream data is played in a clear screen manner, only the video frames are displayed on the virtual space interface. In this regard, the manner of playing the video stream data of the target video in the virtual space interface can be set based on requirements, which is not limited in the embodiments of the disclosure.

In some embodiments, the step of processing the target video based on the control operation corresponding to the video operation information includes: pausing the target video in the virtual space interface based on the pause operation information.

The second terminal obtains the pause operation information for the target video synchronized by the first terminal, and pauses the target video corresponding a video identifier of the target video in the pause operation information in the virtual space interface of the first user account based on the video identifier.

In some embodiments, obtaining the video operation information of the target video synchronized by the first terminal may be performed by establishing a persistent connection with the first terminal, and receiving the video operation information broadcasted by the first terminal through the persistent connection; or by obtaining the streaming media data of the live stream in the live broadcast room of the first user from the content distribution network, and obtaining the video operation information from the streaming media data of the live stream.

Specifically, the second terminal can establish a persistent connection with the first terminal, and obtain the video operation information of the target video through the persistent connection established with the first terminal, thereby effectively reducing the time delay of information transmission, such that the time delay between the second terminal and the first terminal may be reduced and the synchronization of video play between the second terminal and the first terminal may be ensured. For example, the second terminal may establish a persistent connection with the first terminal based on the UDP protocol, and the first terminal broadcasts the video operation information of the target video continuously and uninterruptedly to the second terminal based on the UDP protocol, and when the second user account enters the live broadcast room of the first user to watch the live broadcast through the second terminal, the second terminal receives the real-time video operation information broadcasted by the first terminal through the persistent connection.

Specifically, the first terminal obtains the video operation information of the target video, and writes the video operation information of the target video into the streaming media data of the live stream, uploads the streaming media data of the live stream to the source station of the content distribution network. The second terminal may pull the streaming media data of the live stream in the live room of the first user from the content distribution network, and obtain real-time video operation information from the streaming media data. For example, after obtaining the video operation information of the target video, the first terminal can generate audio synchronization data in the Protobuf data storage format from the video operation information of the target video, and write the audio synchronization data to the streaming media data of the live stream to upload to the source station of the content distribution network. The second terminal pulls the streaming media data of the live stream in the live room of the first user from the content distribution network, and obtains real-time video operation information from the streaming media data.

In some embodiments, the method further includes: receiving streaming media data of the live stream sent by the first terminal, and obtaining speech information from the streaming media data of the live stream and playing the speech information.

In the embodiment of the disclosure, after the target video is played in the live broadcast room of the first user, the first user can send the speech information through the streaming media data of the live stream to the second user account, so that multiple users can watch the video while chatting. The first terminal collects the speech information of the voice chat in the live broadcast room, and distributes the collected speech information to the second terminal that enters the live broadcast room of the first user. After receiving the streaming media data of the live stream sent by the first terminal, the second terminal parses the streaming media data to obtain speech information, and plays the speech information.

Specifically, the first user can send the speech information to the second user account through the streaming media data of the live stream, so that multiple users can chat while watching the video. The first terminal collects the speech information of the host in the live broadcast room or the speech information of the voice chat between the host and the guests, and generates the streaming media data of the live stream based on the collected speech information, and then uploads the streaming media data of the live stream to the source station of the content distribution network. When the second user account enters the live broadcast room of the first user to watch the live broadcast through the corresponding second terminal, the second terminal can initiate a request for viewing the live broadcast in the first user's live broadcast room to the live broadcast server, and pull the streaming media data of the live stream in the first user's live broadcast room from the content distribution network, and obtain real-time first speech information of the host or the speech information of the voice chat between the host and the guest from the streaming media data.

Further, in some embodiments, the method for sharing a video further includes: collecting second speech information of the environment where the second terminal is located, and synchronizing the second speech information to other terminals in the virtual space.

In some embodiments, the method for sharing a video further includes: obtaining a video playlist of the live broadcast room, and displaying the video playlist in the virtual space interface, the video playlist including various video information, as shown in FIG. 3D.

It should be understood that although the various steps in the flowchart of FIG. 2 or FIG. 3 are displayed in sequence as indicated by the arrows, these steps are not necessarily performed in sequence in the order indicated by the arrows. Unless specifically stated, the execution of these steps is not strictly restricted in order, and these steps can be executed in other orders. Moreover, at least part of the steps in FIG. 2 or FIG. 3 may include multiple steps or multiple stages. These steps or stages are not necessarily executed at the same time, but can be executed at different times. The order of execution is not necessarily performed sequentially, but may be performed alternately or alternately with other steps or at least a part of steps or stages in other steps.

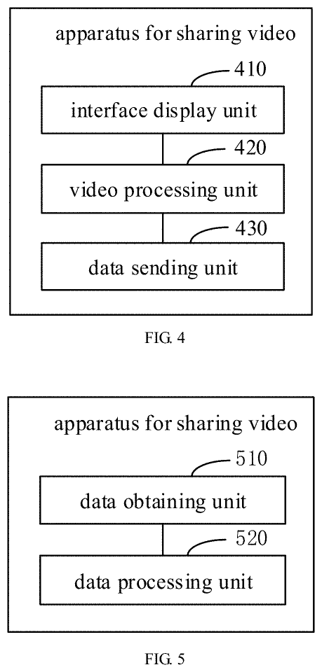

FIG. 4 is a block diagram showing an apparatus for sharing a video based on an embodiment. As shown in FIG. 4, the apparatus is applied to a first terminal, and the first user conducts live broadcast through the first terminal. The apparatus includes an interface display unit 410, a video processing unit 420, and a data sending unit 430.

The interface display unit 410 is configured to obtain the control operation of the first user account for the target video in the virtual space interface of the first user account, in which the first user account is a user account with a first predetermined authority.

The video processing unit 420 is configured to process the target video based on the control operation to obtain video operation information corresponding to the control operation.

The data sending unit 430 is configured to synchronized the video operation information of the target video to a second terminal in a same virtual space as the first terminal.

In some embodiments, the control operation includes but is not limited to a play operation and a pause operation.

In some embodiments, the video processing unit is configured to obtain the video stream data of the target video from a video server in response to the play operation on the target video by the first user account, and play the video stream data of the target video in the virtual space interface.

In some embodiments, the video processing unit is configured to pause the target video in the virtual space interface in response to a pause operation of the first user account on the target video.

In some embodiments, the video operation information includes a video identifier of the target video and control operation information. The data sending unit is configured to upload the video identifier of the target video to a live broadcast server and send the target video identifier to the second terminal through the live broadcast server; write the control operation information into the streaming media data of the live stream, and distribute the control operation information to the second terminal through a content distribution network.

In some embodiments, the video operation information includes a video identifier and control operation information of the target video, and the data sending unit is configured to: upload the video identifier of the target video to a live broadcast server, and send the target video identifier to the second terminal through the live broadcast server; establish a persistent connection with the second terminal, and broadcast the control operation information to the second terminal.

In some embodiments, the apparatus for sharing a video further includes a recommended video obtaining unit. The recommended video obtaining unit is configured to: obtain a recommended channel and a list of recommended videos under the recommended channel based on the account information of the first user account, in which there are multiple recommended videos in the list; and displaying the recommended channel and the recommended videos on the virtual space interface.

In some embodiments, the recommended video obtaining unit is configured to: obtain channel data based on the account information of the first user account, and generate a channel list; determine the recommended channel from the channel list, and obtain the list of recommended videos under the recommended channel based on the channel identifier of the recommended channel.

In some embodiments, the apparatus also includes a video search unit. The video search unit is configured to: display a video search window on the virtual space interface; obtain video keywords inputted by the first user account in the video search window; and display videos related to the video keywords on the virtual space interface.

In some embodiments, the apparatus also includes a first speech collection unit, which is configured to: collect first speech information in an environment where the first terminal is located; generate streaming media data of a live stream based on the first speech information; and distribute the streaming media data to the second terminal.

In some embodiments, the first speech collection unit is further configured to: receive second speech information in an environment where the second terminal is located, in which the second speech information is collected by the second terminal; and generate the streaming media data based on the first speech information and the second speech information.

FIG. 5 is a block diagram of an apparatus for sharing a video based on an embodiment. Referring to FIG. 5, the apparatus is applied to a second terminal and includes: a data obtaining unit 510 and a data processing unit 520.

The data obtaining unit 510 is configured to obtain video operation information of a target video synchronized from a first terminal.

The data processing unit 520 is configured to process the target video in a virtual space interface of a first user account based on a control operation corresponding to the video operation information.

In some embodiments, the video operation information includes but is not limited to play operation information or pause operation information.

In some embodiments, the data processing unit is configured to: obtain video stream data of the target video from a video server; and synchronously play the video stream data in the virtual space interface based on the video stream data and the play operation information.

In some embodiments, the data processing unit is configured to: pause the target video in the virtual space interface based on the pause operation information.

In some embodiments, the apparatus also includes an audio playing unit, which is configured to: receive streaming media data of a live stream sent by the first terminal; obtain speech information from the streaming media data and play the speech information.

In some embodiments, the apparatus also includes a playlist obtaining unit, which is configured to: obtain a video playlist of the live broadcast room, displaying the video playlist on the virtual space interface, in which the video playlist comprises various video information.

In some embodiments, the apparatus also includes a second speech collection unit, which is configured to: collect a second speech information in an environment where the second terminal is located; and synchronize the second speech information to other terminals in the virtual space.

Regarding the apparatus in the foregoing embodiment, the specific manner in which each module performs operation has been described in detail in the embodiment of the method, and detailed description will not be described again.

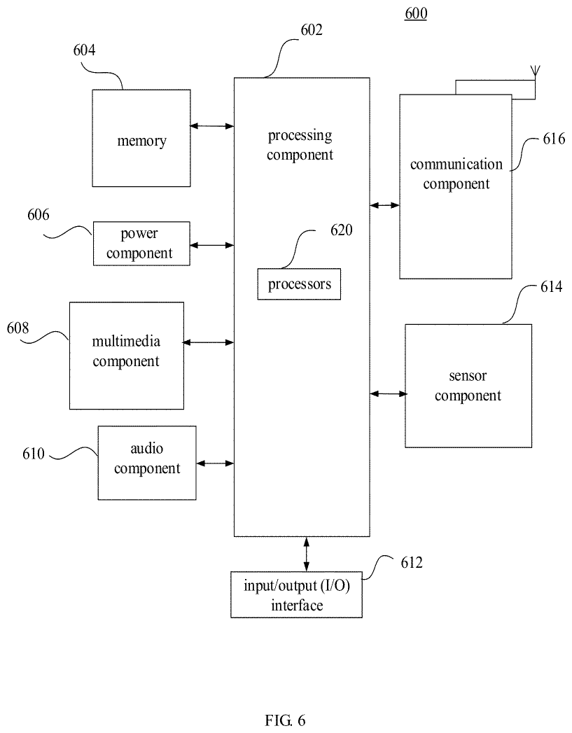

FIG. 6 is a block diagram of a device 600 for live broadcast based on an embodiment. For example, the device 600 may be a mobile phone, a computer, a digital broadcasting terminal, a messaging device, a game console, a tablet device, a medical device, a fitness device, a personal digital assistant, etc.

Referring to FIG. 6, the device 600 may include one or more of the following components: a processing component 602, a memory 604, a power component 606, a multimedia component 608, an audio component 610, an input/output (I/O) interface 612, a sensor component 614, and communication component 616.

The processing component 602 generally controls the overall operations of the device 600, such as operations associated with display, telephone calls, data communications, camera operations, and recording operations. The processing component 602 may include one or more processors 620 to execute instructions to complete all or part of the steps of the foregoing method. In addition, the processing component 602 may include one or more modules to facilitate the interaction between the processing component 602 and other components. For example, the processing component 602 may include a multimedia module to facilitate the interaction between the multimedia component 608 and the processing component 602.

The memory 604 is configured to store various types of data to support the operation of the device 600. Examples of these data include instructions for any application or method operating on the device 600, contact data, phone book data, messages, pictures, videos, and the like. The memory 604 can be implemented by any type of volatile or nonvolatile storage device or a combination thereof, such as static random access memory (SRAM), electrically erasable programmable read-only memory (EEPROM), erasable programmable read only memory (EPROM), programmable read only memory (PROM), read only memory (ROM), magnetic memory, flash memory, magnetic or optical disk.

The power supply component 606 provides power to various components of the device 600. The power supply component 606 may include a power management system, one or more power supplies, and other components associated with generating, managing, and distributing power for the device 600.

The multimedia component 608 includes a screen that provides an output interface between the device 600 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of a touch or slide action, but also detect the duration and pressure related to the touch or slide operation. In some embodiments, the multimedia component 608 includes a front camera and/or a rear camera. When the device 600 is in an operation mode, such as a shooting mode or a video mode, the front camera and/or the rear camera can receive external multimedia data. Each front camera and rear camera can be a fixed optical lens system or have focal length and optical zoom capabilities.

The audio component 610 is configured to output and/or input audio signals. For example, the audio component 610 includes a microphone (MIC), and when the device 600 is in an operation mode, such as a call mode, a recording mode, and a voice recognition mode, the microphone is configured to receive external audio signals. The received audio signal can be further stored in the memory 604 or sent via the communication component 616. In some embodiments, the audio component 610 further includes a speaker for outputting audio signals.

The I/O interface 612 provides an interface between the processing component 602 and a peripheral interface module. The above-mentioned peripheral interface module may be a keyboard, a click wheel, a button, and the like. These buttons may include but are not limited to: home button, volume button, start button, and lock button.

The sensor component 614 includes one or more sensors for providing the device 600 with various aspects of status assessment. For example, the sensor component 614 can detect the open/close state of the device 600 and the relative positioning of components, such as the display and keypad of the device 600. The sensor component 614 can also detect the position change of the device 600 or a component of the device 600, presence or absence of contact between the user and the device 600, the orientation or acceleration/deceleration of the device 600, and the temperature change of the device 600. The sensor component 614 may include a proximity sensor configured to detect the presence of nearby objects when there is no physical contact. The sensor component 614 may also include a light sensor, such as a CMOS or CCD image sensor, for use in imaging applications. In some embodiments, the sensor component 614 may also include an acceleration sensor, a gyroscope sensor, a magnetic sensor, a pressure sensor, or a temperature sensor.

The communication component 616 is configured to facilitate wired or wireless communication between the device 600 and other devices. The device 600 can access a wireless network based on a communication standard, such as WiFi, an operator network (such as 2G 3G 4G or 5G), or a combination thereof. In some embodiments, the communication component 616 receives a broadcast signal or broadcast related information from an external broadcast management system via a broadcast channel. In some embodiments, the communication component 616 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In some embodiments, the device 600 may be implemented by one or more application specific integrated circuits (ASIC), digital signal processors (DSP), digital signal processing devices (DSPD), programmable logic devices (PLD), field programmable gate array (FPGA), controller, microcontroller, microprocessor, or other electronic components are implemented to implement the above methods.

In some embodiments, there is also provided a non-transitory computer-readable storage medium including instructions, such as the memory 604 including instructions, which may be executed by the processor 620 of the device 600 to complete the foregoing method. For example, the non-transitory computer-readable storage medium may be ROM, random access memory (RAM), CD-ROM, magnetic tape, floppy disk, optical data storage device, etc.

It will be understood that, the flow chart or any process or method described herein in other manners may represent a module, segment, or portion of code that comprises one or more executable instructions to implement the specified logic function(s) or that comprises one or more executable instructions of the steps of the progress. Although the flow chart shows a specific order of execution, it is understood that the order of execution may differ from that which is depicted. For example, the order of execution of two or more boxes may be scrambled relative to the order shown.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

Those skilled in the art will easily achieve other embodiments of the disclosure after considering the description and practicing the invention disclosed herein. The disclosure is intended to cover any variations, uses, or adaptive changes of the disclosure. These variations, uses, or adaptive changes follow the general principles of the disclosure and include common knowledge or conventional technical means in the technical field not disclosed in the disclosure. The description and the embodiments are only regarded as exemplary, and the true scope and spirit of the disclosure are pointed out by the following claims.

It should be understood that the disclosure is not limited to the precise structure that has been described above and shown in the drawings, and various modifications and changes can be made without departing from its scope. The scope of the disclosure is only limited by the appended claims.

What is claimed is:

1. A method for sharing a video, applied to a first terminal and comprising:
acquiring a control operation of a first user account for a target video, wherein the target video is in a virtual space interface of the first user account;
obtaining video operation information corresponding to the control operation by processing the target video in response to the control operation; and
synchronizing the video operation information to a second terminal, wherein the second terminal is in a same virtual space as the first terminal.

2. The method of claim 1, wherein the control operation comprises a play operation or a pause operation.

3. The method of claim 2, wherein said processing the target video comprises:
obtaining video stream data of the target video from a video server in response to the play operation; and
playing the video stream data in the virtual space interface.

4. The method of claim 1, wherein the video operation information comprises a video identifier and control operation information of the target video.

5. The method of claim 4, wherein said synchronizing the video operation information to the second terminal comprises:
uploading the video identifier to a live broadcast server, wherein the video identifier is sent to the second terminal by the live broadcast server; and
writing the control operation information into streaming media data of a live stream, wherein the streaming media data is uploaded to a content distribution network and the control operation information is obtained by the second terminal through pulling the streaming media data from the content distribution network.

6. The method of claim 4, wherein said synchronizing the video operation information to the second terminal comprises:
uploading the video identifier to a live broadcast server, wherein the video identifier is sent to the second terminal by the live broadcast server, and video stream data of the target video is obtained by the second terminal from a video server based on the video identifier; and
establishing a persistent connection with the second terminal, and broadcasting the control operation information to the second terminal.

7. The method of claim 1, further comprising:
obtaining a recommended channel and recommended videos corresponding to the recommended channel based on account information of the first user account; and
displaying the recommended channel and the recommended videos on the virtual space interface, wherein the target video is selected from the recommended videos.

8. The method of claim 7, wherein said obtaining the recommended channel and the recommended videos comprises:
generating a channel list based on account information of the first user account; and
determining the recommended channel from the channel list, and obtaining the recommended videos based on a channel identifier of the recommended channel.

9. The method of claim 1, further comprising:
displaying a video search window on the virtual space interface;
receiving a video keyword inputted by the first user account in the video search window; and
displaying videos related to the video keyword on the virtual space interface, wherein the target video is from the videos related to the video keyword.

10. A method for sharing a video, applied to a second terminal and comprising:
obtaining video operation information of a target video synchronized from a first terminal, wherein the first terminal and the second terminal are in a same virtual space; and
processing the target video in a virtual space interface of a first user account based on the video operation information.

11. The method of claim 10, wherein the video operation information comprises a video identifier and control operation information, and the control operation information comprises play operation information or pause operation information.

12. The method of claim 11, wherein said processing the target video comprising:
obtaining video stream data of the target video from a video server based on the video identifier; and
playing the video stream data in the virtual space interface based on the video stream data and the play operation information.

12. The method of claim 10, wherein said obtaining the video operation information comprises:
establishing a persistent connection with the first terminal; and
receiving the video operation information broadcasted by the first terminal through the persistent connection.

13. The method of claim 10, wherein said obtaining the video operation information comprises:
pulling streaming media data of a live stream from a content distribution network, wherein the streaming media data is uploaded to the content distribution network by the first terminal; and
obtaining the video operation information from the streaming media data.

14. An apparatus for sharing a video, applied to a first terminal, comprising:
one or more processors;
a memory coupled to the one or more processors,
a plurality of instructions stored in the memory, when executed by the one or more processors, causing the one or more processors to perform acts of:
acquiring a control operation of a first user account for a target video, wherein the target video is in a virtual space interface of the first user account;
obtaining video operation information corresponding to the control operation by processing the target video in response to the control operation; and
synchronizing the video operation information to a second terminal, wherein the second terminal is in a same virtual space as the first terminal.

15. The apparatus of claim 14, wherein the control operation comprises a play operation or a pause operation, and said processing the target video comprises:
obtaining video stream data of the target video from a video server in response to the play operation; and
playing the video stream data in the virtual space interface.

16. The apparatus of claim 14, wherein the video operation information comprises a video identifier and control operation information of the target video.

17. The apparatus of claim 16, wherein said synchronizing the video operation information to the second terminal comprises:
uploading the video identifier to a live broadcast server, wherein the video identifier is sent to the second terminal by the live broadcast server; and
writing the control operation information into streaming media data of a live stream, wherein the streaming media data is uploaded to a content distribution network and the control operation information is obtained by the second terminal through pulling the streaming media data from the content distribution network.

18. The apparatus of claim 16, wherein said synchronizing the video operation information to the second terminal comprises:
uploading the video identifier to a live broadcast server, wherein the video identifier is sent to the second terminal by the live broadcast server, and video stream data of the target video is obtained by the second terminal from a video server based on the video identifier; and
establishing a persistent connection with the second terminal, and broadcasting the control operation information to the second terminal.

19. The apparatus of claim 14, wherein the one or more processors are further caused to perform acts of:
obtaining a recommended channel and recommended videos corresponding to the recommended channel based on account information of the first user account; and
displaying the recommended channel and the recommended videos on the virtual space interface, wherein the target video is selected from the recommended videos.

20. A non-transitory computer-readable storage medium, applied to a first terminal, wherein when an instruction stored therein is executed by a processor in an electronic device, the processor is caused to perform acts comprising:
acquiring a control operation of a first user account for a target video, wherein the target video is in a virtual space interface of the first user account;
obtaining video operation information corresponding to the control operation by processing the target video in response to the control operation; and
synchronizing the video operation information to a second terminal, wherein the second terminal is in a same virtual space as the first terminal.
